(19) United States
(12) Patent Application Publication
(10) Pub. No.: US 2026/0061407 A1
(43) Pub. Date: Mar. 5, 2026

(54) Hydrocracking Composite Catalysts Based on Zeolite and Amorphous Silica-Alumina

(71) Applicant: Saudi Arabian Oil Company, Dhahran (SA)

(72) Inventors: Batool Altaher, Dammam (SA); Lianhui Ding, Dhahran (SA); Mohammad F. Aljishi, Dhahran (SA); Faisal Alotaibi, Al Khobar (SA); Mohammed Z. Al-Bahar, Dhahran (SA); Faisal M. Almulla, Dhahran (SA)

(21) Appl. No.: 18/819,332

(22) Filed: Aug. 29, 2024

(51) Int. Cl. B01J 29/80; B01J 21/04; B01J 29/16; B01J 29/78; B01J 35/80; B01J 37/00; B01J 37/02; B01J 37/03; B01J 37/04; B01J 37/06; B01J 37/08; C10G 47/20

(52) U.S. Cl. CPC B01J 29/80; B01J 21/04; B01J 29/166; B01J 29/7815; B01J 35/80; B01J 37/0009; B01J 37/009; B01J 37/0201; B01J 37/031; B01J 37/04; B01J 37/06; B01J 37/08; C10G 47/20; B01J 2229/14; B01J 2229/38; C10G 2300/1037; C10G 2300/1074; C10G 2300/1077; C10G 2400/04

(57) ABSTRACT

A method of catalytic hydrocracking. The method includes flowing a hydrocarbon feed comprising a heavy oil into a hydrocracking unit; and hydrocracking the hydrocarbon feed in the hydrocracking unit using a composite catalyst. The composite catalyst includes an ordered amorphous silica-alumina (OASA) having mesopores, a zeolite component having micropores, a first metal component, a second metal component, and a support material, where at least a fraction of the heavy oil is converted within the mesopores into an intermediate, and at least a fraction of the intermediate is further converted within the micropores to form a product stream including a middle distillate fraction.

### TECHNICAL FIELD

This document relates to hydrocracking composite catalysts based on zeolite and amorphous silica-alumina.

### BACKGROUND

With the demand for clean fuel and petrochemicals, it would be beneficial to convert heavy oils to high-value hydrocarbons. Hydrocracking is a widely used process in petroleum refining to convert heavy oil fragments into clean fuels such as diesel through the breakage of C—C bonds. Hydrocracking technologies enable the production of high-value naphtha and distillate products from a wide range of refinery feedstocks. Generally, a hydrocracking process combines catalytic cracking and hydrogenation, where heavier feedstocks can be cracked in the presence of hydrogen into lighter oil products. The cracking of hydrocarbons typically uses thermally stable solid catalysts such as crystalline zeolite catalysts (e.g., zeolite Y, beta zeolite), amorphous silica-alumina (ASA), and alumina. Since heavy oils such as crude oil contain a large volume of heavier, bulkier molecules compared to lighter oils, catalysts with special characteristics in surface area, acid strength, and pore structure for the accessibility of catalytic sites are desired.

### SUMMARY

This disclosure describes technologies relating to hydrocracking composite catalysts based on zeolite and amorphous silica-alumina.

An implementation described here provide a method of catalytic hydrocracking. The method includes flowing a hydrocarbon feed comprising a heavy oil into a hydrocracking unit; and hydrocracking the hydrocarbon feed in the hydrocracking unit using a composite catalyst. The composite catalyst includes an ordered amorphous silica-alumina (OASA) having mesopores, a zeolite component having micropores, a first metal component, a second metal component, and a support material, where at least a fraction of the heavy oil is converted within the mesopores into an intermediate, and at least a fraction of the intermediate is further converted within the micropores to form a product stream including a middle distillate fraction.

In an aspect, the OASA is prepared by at least partially hydrolyzing a first zeolite to form the mesopores, and the zeolite component includes a second zeolite.

In an aspect, combinable with any other aspect, the first zeolite includes a zeolite Y.

In an aspect, combinable with any other aspect, the second zeolite includes a zeolite Y.

In an aspect, combinable with any other aspect, the zeolite component includes a third zeolite

In an aspect, combinable with any other aspect, the third zeolite includes a beta zeolite.

In an aspect, combinable with any other aspect, a weight ratio of the OASA to the zeolite component in the composite catalyst is from 5:1 to 20:1.

In an aspect, combinable with any other aspect, the OASA is from 30 wt. % to 50 wt. % of the composite catalyst.

In an aspect, combinable with any other aspect, the first metal component includes molybdenum or tungsten, and the second metal component includes nickel.

In an aspect, combinable with any other aspect, the first metal component is a first metal oxide, and the second metal component is a second metal oxide.

In an aspect, combinable with any other aspect, the support material includes alumina.

In an aspect, combinable with any other aspect, the composite catalyst is an extrudate including a binder.

In an aspect, combinable with any other aspect, the composite catalyst includes: 30-50 wt. % the OASA; 15-25 wt. % the binder; 14-20 wt. % the first metal component; 5-15 wt. % the support material; 4-8 wt. % the second metal component; and 2-15 wt. % the zeolite component.

In an aspect, combinable with any other aspect, the heavy oil includes vacuum gas oil (VGO), residua, bitumen, or heavy crude oil.

In an aspect, combinable with any other aspect, the middle distillate includes diesel oil.

In an aspect, combinable with any other aspect, the hydrocracking is performed at a temperature below 400° C., and a yield of the diesel oil from the hydrocracking is at least 30%.

An implementation described here provides a method of preparing a hydrocracking catalyst. The method includes: forming an ordered amorphous silica-alumina (OASA) including mesopores by at least partially hydrolyzing a first zeolite; mixing the OASA with a second zeolite to form a catalyst precursor mixture; adding a binder and a support material to the catalyst precursor mixture to form a catalyst paste; extruding the catalyst paste to form a catalyst extrudate; and calcining the catalyst extrudate to form a composite catalyst. The composite catalyst includes the OASA, the second zeolite, a first metal component, a second metal component, the binder, and the support material.

In an aspect, combinable with any other aspect, the method further includes adding a first precursor for the first metal component, a second precursor for the second metal component, and the support material to the catalyst precursor mixture prior to extruding the catalyst paste.

In an aspect, combinable with any other aspect, the method further includes, after extruding the catalyst paste and prior to calcining the catalyst extrudate, adding a first precursor for the first metal component and a second precursor for the second metal component to the catalyst extrudate using an impregnation method.

In an aspect, combinable with any other aspect, forming the OASA includes: adding the first zeolite in an alkali aqueous solution to form a mixture solution; adding a structure-directing agent to the mixture solution; holding the mixture solution at a first reaction temperature for 24 h or more; recovering a precipitate from the mixture solution; and calcining the precipitate to form the OASA.

An implementation described here provides an extrudate catalyst composition including: 30-50 wt. % an ordered amorphous silica-alumina (OASA) having mesopores; 15-25 wt. % a binder; 14-20 wt. % a first metal component; 5-15 wt. % a support material; 4-8 wt. % a second metal component; and 2-15 wt. % a zeolite component.

In an aspect, combinable with any other aspect, the first metal component includes molybdenum oxide, the second metal component includes nickel oxide, and the support material includes alumina.

In an aspect, combinable with any other aspect, the OASA is formed by at least partially hydrolyzing a first zeolite Y, and the zeolite component includes a second zeolite Y and a beta zeolite.

In an aspect, combinable with any other aspect, the first zeolite Y is CBV-720 or CBV-760.

In an aspect, combinable with any other aspect, the second zeolite Y is CBV-720 or CBV-760.

In an aspect, combinable with any other aspect, the OASA has a silica to aluminum (SiO₂/Al₂O₃) molar ratio greater than 20.

### BRIEF DESCRIPTION OF THE DRAWINGS

For a more complete understanding of the implementations described herein, and the advantages thereof, reference is now made to the following descriptions taken in conjunction with the accompanying figures, in which:

FIG. 1 shows a schematic of a composite catalyst based on an ordered amorphous silica-alumina (OASA) and a zeolite for hydrocracking of heavy oil.

FIG. 2 is a process flow diagram of an example method of preparing a composite catalyst of the present disclosure.

FIG. 3 is a process flow diagram of an example method of hydrocracking using a composite catalyst of the present disclosure.

FIG. 4 shows an example processing facility, including a hydrocracking unit, that directly converts crude oil into petrochemicals.

### DETAILED DESCRIPTION

This disclosure describes novel hydrocracking catalyst formulations designed for hydrocracking heavy oil into middle-distillate fractions and synthetic methods of making the catalyst formulations. Specifically, the catalyst formulation is based on the combined use of ordered amorphous silica-alumina (OASA) and one or more zeolites. For example, for the zeolite components, hierarchical Y zeolite can be used. Further, the zeolite components can include a second zeolite such as nano-sized beta zeolite. The catalyst can further include metal components, e.g., MoO₃ and NiO. The catalyst can also include support material such as alumina. The catalyst can also include a binder for extruding. The OASA, which can be prepared from a zeolite by partially degrading its zeolitic structure, offers ordered mesopore channels, higher pore volume and surface area with high acidity. These characteristics can be beneficial in enhancing mass transfer and improving selectivity toward middle-distillate fractions. In some implementations, a fraction of the cracked molecules from the OASA can then diffuse into the adjacent hierarchical zeolite Y or nano-sized zeolite beta for further cracking. Using the two zeolite topologies, more heavy oil can be converted to middle-distillate fractions which can generate high value products such as diesel. The catalyst formulation can include one or more metal components, which can be introduced to the catalyst formation before or after the extrusion.

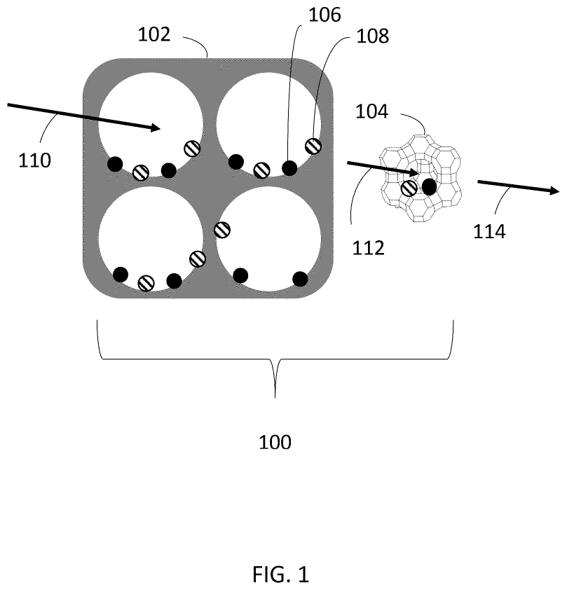

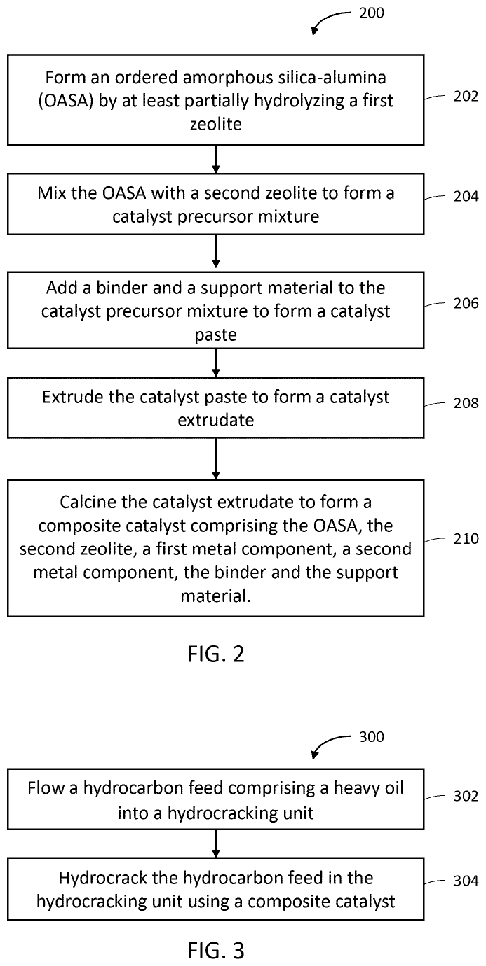

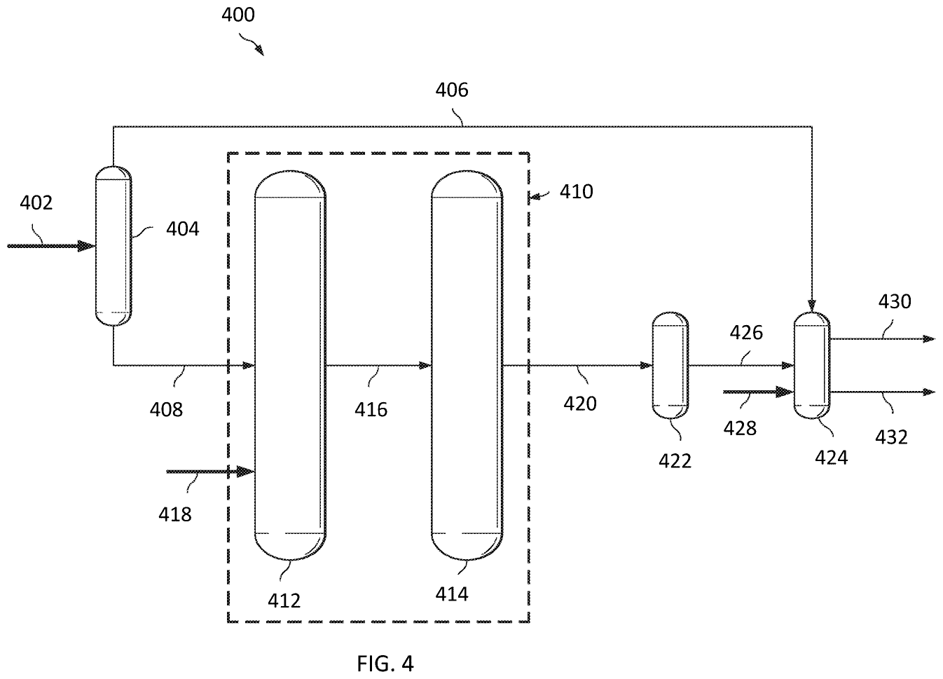

In the following, the concept of a composite catalyst based on an OASA with mesopores and a zeolite with micropores is described referring to FIG. 1, followed by various preparation methods for the composite catalyst and an example preparation process flow diagram in FIG. 2. Methods of hydroprocessing of a hydrocarbon feed using the composite catalyst to produce a lighter hydrocarbon product stream are then described referring to FIGS. 3 and 4.

### Catalyst Design

FIG. 1 shows a schematic of a composite catalyst 100. The composite catalyst 100 is comprised of multiple components including more than one catalytically active species for hydrocracking of hydrocarbon. In various implementations, composite catalyst 100 includes an ordered amorphous silica-alumina (OASA) 102 and a zeolite component 104. Both the OASA 102 and zeolite component 104 can provide catalytically active acid sites for cracking. Further, the composite catalyst 100 can include one or metal components that can catalyze reactions with hydrogen, e.g., hydrogenation. As illustrated in FIG. 1, the metal components can include a first metal component 106 and a second metal component 108. In some implementations, the first metal component 106 includes molybdenum (Mo) or tungsten (W) species. In some implementations, the second metal component 108 includes nickel (Ni) species. Although omitted in FIG. 1 for illustration purpose, the composite catalyst 100 can be an extruded catalyst that includes a support material and a binder.

In various implementations, the OASA 102 provides mesopores, e.g., average pore size from about 2 nm to about 50 nm, and the zeolite component 104 provides micropores, e.g., average pore size less than about 2 nm. Both the OASA 102 and zeolite component 104 can provide a range of acidity that can be catalytically active for cracking various hydrocarbon molecules under reaction conditions. This pair of two different porous structures in the composite catalyst 100 can help efficiently convert the relatively large hydrocarbon molecules, e.g., a kinetic diameter of 2 nm or larger, in the feed by providing a reaction space and access to more catalytically active sites within the pores.

In general, for hydrocracking of heavy oil such as vacuum gas oil (VGO), residua, bitumen, and heavy crude oil, the pore size of the conventional zeolite Y and beta zeolite is too narrow for large molecules in the heavy oil to diffuse into the active sites located inside the zeolite micropores to further be cracked into lighter products. Therefore, to improve the catalytic performance specifically for the heavy oil, it can be desired to increase the pore size and external surface area. In various implementations of this disclosure, the composite catalyst achieves this goal by combining the OASA 102 and the zeolite component 104 in one catalyst system to provide a high surface area and a high pore volume with controlled distribution of acidity. In some implementations, the lower acidity of the OASA 102 compared to regular crystalline zeolites prevents the heavier molecules from being over cracked, maintaining a desired catalytic activity and performance of the composite catalyst 100. In some implementations, hydrocracking involves stepwise conversions of the heavy molecules. For example, a hydrocarbon feed 110 can be converted by the composite catalyst 100, where the large molecules can be first cracked into an intermediate 112. Subsequently, the intermediate 112 can further be converted by the zeolite component 104, including the catalytic sites within the micropores where the large molecules are too large to enter, into smaller molecules to form a product stream 114. Hydrogenation can take place over the metal components that can be dispersed on the surface of the OASA 102, the zeolite component 104, the support material, or any combination thereof.

In some implementations, the term “heavy oil” is used to refer to hydrocarbon mixtures having a boiling range around 320° C. or above. For example, it can include heavy gas oil having a boiling range from about 320° C. to about 425° C. In some implementations, heavy oil includes light VGO having a boiling range from about 425° C. to about 510° C. In some implementations, heavy oil includes heavy VGO having a boiling range from about 510° C. to about 565° C. In some implementations, heavy oil includes vacuum residue having a boiling range about 560° C. or above.

In some implementations, the term “middle-distillate fraction” is used to refer to hydrocarbon mixtures having a boiling range around 160° C. or above. For example, it can include kerosene having a boiling range from about 180° C. to about 370° C. In some implementations, middle-distillate fractions include diesel having a boiling range from about 170° C. to about 370° C. In some implementations, it can include light gas oil having a boiling range from about 270° C. to about 320° C.

In various implementations, the composite catalyst 100 is prepared stepwise by separately preparing at least one or more of the components, e.g., the OASA 102 and the zeolite component 104, and physically mixing them to form a composite material that can be synthesized by partially hydrolyzing a crystalline zeolite as a precursor.

### OASA Preparation

The OASA 102 can be prepared by at least partially hydrolyzing a crystalline zeolite as a precursor. For example, the process includes treating a zeolite with a basic solution to form a first product. In some implementations, the first product includes disintegrated building blocks. In some implementations, the zeolite is zeolite Y. In some implementations, the basic solution is a sodium hydroxide (NaOH) aqueous solution. Subsequently, the first product can be reacted with a structure-directing agent. An example of the structure-directing agent includes cetyltrimethylammonium bromide (CTAB). The reaction with the structure-directing agent results in a second product. In some implementations, the second product includes a self-assembled porous intermediate. The second product can then be calcined to form the amorphous silica-alumina that retains a portion of the ordered pore structure, termed as ordered amorphous silica-alumina (OASA).

In various implementations, the preparation of the OASA 102 is a top-down method rather than more conventional bottom-up methods for preparing amorphous silica-alumina. Bottom-up methods typically start with silica and aluminum sources which are coprecipitated to prepare the amorphous product. In contrast, the top-down method can start with a commercial crystalline zeolite as a precursor and include at least partially breaking the crystalline structure of the precursor, e.g., by treating with a basic solution, to form the amorphous product containing small zeolite building units.

In some implementations, the zeolite Y is used for preparing the OASA 102. Further, the zeolite precursor can have a high silica to aluminum (SiO₂/Al₂O₃) molar ratio greater than 20. For example, commercial zeolite Y samples from Zeolyst such as CBV-720 (SiO₂/Al₂O₃ molar ratio of about 30) and CBV-760 (SiO₂/Al₂O₃ molar ratio of about 60) can be used. In some implementations, the high SiO₂/Al₂O₂ molar ratio improves the zeolite acidity and stability, which can benefit the catalytic performance for hydrocracking processes. Accordingly, the zeolite precursor can have a SiO₂/Al₂O₃ molar ratio greater than 10, greater than 20, greater than 30, greater than 40, greater than 50, greater than 60, or greater than 70. For example, the SiO₂/Al₂O₃ molar ratio can be from about 10 to about 70, from about 20 to about 70, from about 30 to about 70, from about 40 to about 70, from about 50 to about 70, from about 60 to about 70, from about 10 to about 60, from about 10 to about 50, from about 10 to about 40, from about 10 to about 30, or from about 10 to about 20.

In some implementations, the OASA 102 has a surface area of at least 900 m²/g, at least 1000 m²/g, at least 1100 m²/g, or at least 1200 m²/g. In some implementations, the OASA 102 has a surface area from about 900 m²/g to about 1200 m²/g, e.g., from about 1000 m²/g to about 1200 m²/g, from about 1100 m²/g to about 1200 m²/g, from about 900 m²/g to about 1100 m²/g, or from about 900 m²/g to about 1000 m²/g.

In some implementations, the OASA 102 has a pore volume of at least 0.9 ml/g, at least 1.0 ml/g, at least 1.1 ml/g, or at least 1.2 ml/g. In some implementations, the OASA 102 has a pore volume from about 0.9 ml/g to about 1.2 ml/g, e.g., from about 1.0 ml/g to about 1.2 ml/g, from about 1.1 ml/g to about 1.2 ml/g, from about 0.9 ml/g to about 1.1 ml/g, or from about 0.9 ml/g to about 1.0 ml/g.

In some implementations, the OASA 102 has pore sizes of at least 4 nm, at least 5 nm, at least 6 nm, or at least 9 nm. In some implementations, the OASA 102 has pore sizes from about 4 nm to about 9 nm, e.g., from about 5 nm to about 9 nm, from about 6 nm to about 9 nm, from about 5 nm to about 9 nm, or from 6 nm to about 9 nm.

In various implementations, treating the zeolite precursor for the OASA 102 with the basic solution includes heating the reaction mixture, e.g., to a temperature from about 30° C. to about 90° C., from about 40° C. to about 90° C., from about 50° C. to about 90° C., from about 60° C. to about 90° C., from about 70° C. to about 90° C., or from about 80° C. to about 90° C.

Further, treating the zeolite precursor for the OASA 102 with the basic solution includes agitating the reaction mixture, for example, by using a magnetic stirrer. The reaction mixture can be agitated for from about 2 h to about 8 h, e.g., from about 4 h to about 8 h, from about 6 h to about 8 h, from about 2 h to about 6 h, or from about 2 h to about 4 h.

The partial hydrolysis induced by the treatment with the basic solution can break down at least portions of the zeolite precursors into primary or second building blocks. These disintegrated building blocks can be re-assembled around the structure-defining agents to form an ordered pore structure with pore sizes in mesopore range. Accordingly, the preparation of the OASA 102 can further include reacting the disintegrated building blocks with a structure-directing agent. In some implementations, the structure-defining agents form micelles around which the zeolite building units assemble in solution. Examples of the structure-directing agent include cetyltrimethylammonium bromide (CTAB), and ethylene oxide (EO) and propylene oxide (PO) copolymer surfactant. In some implementations, the EO-PO copolymer surfactant can be Pluronic® P-123 with a 30% EO content or Pluronic® F-127 with a 70% EO content. For example, micelles formed in a solution by the structure-defining agents can have a rod-shape. The rod-shaped micelles can further organize relative to each other, and the disintegrated building units self-assemble around the micelles to form the self-assembled intermediate.

The structure-directing agent can be suspended in a second solvent, e.g., water. The suspension may be added slowly to the first product, e.g., the disintegrated building blocks, suspended in the first solvent, e.g., water, and agitated for at least about 2 h, at least about 4 h, at least about 6 h, or at least about 8 h. In some implementations, the sample is agitated for from about 10 h to about 24 h, e.g., from about 15 h to about 24 h, from about 20 h to about 24 h, from about 10 h to about 20 h, or from about 10 h to about 15 h. Slow addition of the suspension can include dropwise addition of the suspension/solution.

In some implementations, the structure-directing agent to zeolite precursor weight ratio is from about 0.5 to about 3.0, e.g., from about 1.0 to about 3.0, from about 2.0 to about 3.0, from about 0.5 to about 2.0, or from 0.5 to about 1.0.

In some implementations, the first solvent to zeolite precursor weight ratio is from about 10 to about 80, e.g., from about 30 to about 80, from about 50 to about 80, from about 70 to about 80, from about 10 to about 50, or from about 10 to about 30.

In some implementations, the second product is heated at least about 40° C., at least about 60° C., or at least about 100° C. for at least about 4 h, at least about 6 h, at least about 8 h, or at least about 10 h. For example, the second product is heated between about 60° C. to about 140° C. for between about 10 h to about 40 h. The second product can be heated in an autoclave at about or above atmospheric pressure.

The self-assembled intermediate can be collected from the suspension, for example, by filtering, washed to remove any unreacted reagents, and dried. The collected sample can be dried at an elevated temperature at from about 100° C. to about 150° C., e.g., from about 120° C. to about 150° C., from about 140° C. to about 150° C., from about 100° C. to about 140° C., or from about 100° C. to about 120° C. The collected sample can be dried for from about 4 h to about 24 h.

The dried sample can be then calcined to remove any residual organics, e.g., the structure-directing agent, and form the OASA 102. The calcination temperature can be at least about 400° C., e.g., from about 400° C. to about 550° C., from about 450° C. to about 550° C., from about 500° C. to about 550° C., from about 400° C. to about 500° C., or from about 400° C. to about 450° C. The calcination can be performed for from about 2 h to about 6 h, e.g., from about 4 h to about 6 h or from about 2 h to about 4 h.

### Composite Catalyst Preparation

In various implementations, the zeolite component 104 is a single zeolite species or contains more than one zeolite. For example, the zeolite component 104 can be a commercial zeolite Y, e.g., Zeolyst CBV-720 or CBV-760, or a modified zeolite, e.g., hierarchical zeolite Y. In some implementations, the zeolite component 104 is a zeolite composite material that contains a first zeolite and a second zeolite. For example, the zeolite composite material can include zeolite Y and beta zeolite.

In some implementations, the zeolite component 104 is a hierarchical zeolite Y/nano-sized zeolite beta composite prepared according to U.S. Patent Publication US2021/0170376A1, which is incorporated by reference. Briefly, the preparation of the hierarchical zeolite Y/nano-sized zeolite beta can be as follows: a commercial zeolite Y, e.g., CBV-720 or CBV-760, is treated with a 0.2-5.0 M aqueous NH₃ and CTAB solution at 60-120° C. for 1 to 48 h; the treated sample is washed, dried, and calcined to form the hierarchical zeolite Y; a zeolite beta gel comprising particles of nano-sized zeolite beta is synthesized, for example, using a hydrothermal method, where an aluminum-containing aqueous tetraethyl amine hydroxide (TEAOH) solution and a silica-containing aqueous TEAOH solution were mixed and reacted; water is added to the zeolite beta gel to form a zeolite beta slurry; the hierarchical zeolite Y is added to the zeolite beta slurry and thoroughly mixed; and the resulting slurry is then dried at an elevated temperature, e.g., from about 90° C. to about 130° C., for from about 2 h to about 10 h.

The OASA 102 and the zeolite component 104 can be thoroughly mixed to form a uniform composition. For example, these two samples in solid form are physically mixed using a blender, a mixer, or a mortar and pestle, forming a catalyst precursor mixture. Further, a binder and a support material can be added to the catalyst precursor mixture to form a catalyst paste. In some implementations, the binder includes acid peptized alumina. For example, a commercial alumina such as Catapal B from Sasol can be mixed with a diluted nitric acid (HNO₃) solution to form the binder. An example of the support material is alumina. The catalyst paste can then be extruded to from a catalyst extrudate, which is then calcined to form the composite catalyst 100. As referred to herein, extrudates are catalyst particles formed by cutting an extruded catalyst rope into discrete particles in a pelletizer. The extrudates can be any number of shapes, such as cylinders, tri-lobes, tetra-lobes, stars, wheels, or any other shapes generally known in the art.

In some implementations, the composite catalyst 100 further includes metal components. The metal components can be added to the catalyst formulation before or after the extrusion. The metal components can include metal oxides in the composite catalyst 100. Accordingly, in the catalyst preparation stage of some implementations, metal-containing precursors can be used and they can be converted to one or more metal oxides as the metal components in the composite catalyst 100. Further, in various implementations, the composite catalyst 100 can be further activated prior to the use in a hydroprocessing facility. An example of the activation step is sulfiding, where the catalyst is reacted with a stream containing hydrogen disulfide (H₂S) to form a sulfided form of the catalyst as an active phase for the hydroprocessing.

In some implementations, a pre-extrusion mixing method is used, where the catalyst precursor mixture including the OASA 102 and the zeolite component 104 can be mixed with one or more metal sources, together with the binder and support material. After the addition of metal sources, the mixture can be extruded using an extruder. Examples of the metal sources include molybdenum oxide and nickel nitrate. Subsequently, the extrudate can be dried at a temperature from about 100° C. to about 120° C. for from about 2 h to about 8 h. The dried extrudate can be then calcined at a temperature at least about 400° C., e.g., from about 400° C. to about 550° C., from about 450° C. to about 550° C., from about 500° C. to about 550° C., from about 400° C. to about 500° C., or from about 400° C. to about 450° C. The calcination can be performed for from about 2 h to about 6 h, e.g., from about 4 h to about 6 h or from about 2 h to about 4 h.

In other implementations, a post-extrusion mixing method is used. For example, an impregnation method can be used, where the catalyst precursor mixture, after adding the binder and the support material, can be extruded using an extruder. The extrudate can then be dried and calcined at a temperature from about 500° C. to about 700° C., e.g., from about from about 550° C. to about 700° C., from about 600° C. to about 700° C., from about 650° C. to about 700° C., from about 500° C. to about 650° C., from about 500° C. to about 600° C., or from about 500° C. to about 550° C. The calcination can be performed for from about 2 h to about 6 h, e.g., from about 4 h to about 6 h or from about 2 h to about 4 h. After the calcination, the calcined extrudate can be impregnated with the metal sources, for example, using one or more aqueous solutions containing metal precursors. Examples of the metal precursors to prepare the solutions include nickel nitrate hexahydrate and ammonium metatungstate. After impregnation, the impregnated extrudate can be dried at a temperature from about 100° C. to about 120° C. for from about 2 h to about 8 h. The dried extrudate can be then calcined at a temperature at least about 400° C., e.g., from about 400° C. to about 550° C., from about 450° C. to about 550° C., from about 500° C. to about 550° C., from about 400° C. to about 500° C., or from about 400° C. to about 450° C. The calcination can be performed for from about 2 h to about 6 h, e.g., from about 4 h to about 6 h or from about 2 h to about 4 h.

In some implementations, in the composite catalyst 100, a weight ratio of the OASA 102 to the zeolite component 104 is from 5:1 to 20:1, e.g., from about 10:1 to about 20:1, from about 15:1 to about 20:1, from about 5:1 to about 15:1, from about 5:1 to about 10:1.

In some implementations, the OASA 102 is from 30 wt. % to 50 wt. % of the composite catalyst 100, e.g., from about 35 wt. % to about 50 wt. %, from about 40 wt. % to about 50 wt. %, from about 45 wt. % to about 50 wt. %, from about 30 wt. % to about 45 wt. %, from about 30 wt. % to about 40 wt. %, or from about 30 wt. % to about 35 wt. %.

In some implementations, the binder is from 15 wt. % to 25 wt. % of the composite catalyst 100, e.g., from about 18 wt. % to about 25 wt. %, from about 20 wt. % to about 25 wt. %, from about 22 wt. % to about 25 wt. %, from about 15 wt. % to about 22 wt. %, from about 15 wt. % to about 20 wt. %, or from about 15 wt. % to about 18 wt. %.

In some implementations, the first metal component 106 is from 14 wt. % to 20 wt. % of the composite catalyst 100, e.g., from about 15 wt. % to about 20 wt. %, from about 17 wt. % to about 20 wt. %, from about 19 wt. % to about 20 wt. %, from about 14 wt. % to about 19 wt. %, from about 14 wt. % to about 17 wt. %, or from about 14 wt. % to about 15 wt. %.

In some implementations, the support material is from 5 wt. % to 15 wt. % of the composite catalyst 100, e.g., from about 8 wt. % to about 15 wt. %, from about 10 wt. % to about 15 wt. %, from about 12 wt. % to about 15 wt. %, from about 5 wt. % to about 12 wt. %, from about 5 wt. % to about 10 wt. %, or from about 5 wt. % to about 8 wt. %.

In some implementations, the second metal component 108 is from 4 wt. % to 8 wt. % of the composite catalyst 100, e.g., from about 5 wt. % to about 8 wt. %, from about 6 wt. % to about 8 wt. %, from about 7 wt. % to about 8 wt. %, from about 4 wt. % to about 7 wt. %, from about 4 wt. % to about 6 wt. %, or from about 4 wt. % to about 5 wt. %.

In some implementations, the zeolite component 104 is from 2 wt. % to 15 wt. % of the composite catalyst 100, e.g., from about 5 wt. % to about 15 wt. %, from about 9 wt. % to about 15 wt. %, from about 13 wt. % to about 15 wt. %, from about 2 wt. % to about 13 wt. %, from about 2 wt. % to about 9 wt. %, or from about 2 wt. % to about 5 wt. %.

In some implementations, the composite catalyst 100 includes 30-50 wt. % the OASA, 15-25 wt. % the binder, 14-20 wt. % the first metal component, 5-15 wt. % the support material, 4-8 wt. % the second metal component; and 2-15 wt. % the zeolite component.

FIG. 2 is an example process flow diagram of a method of preparing a composite catalyst of the present disclosure. In FIG. 2, process 200 starts with step 202 of forming an OASA with mesopores by at least partially hydrolyzing a first zeolite. In step 204, the OASA is mixed with a second zeolite to form a catalyst precursor mixture, followed by step 206 of adding a binder and a support material to the catalyst precursor mixture to form a catalyst paste. Subsequently, in step 208, the catalyst paste is extruded to form a catalyst extrudate, and in step 210, the catalyst extrudate is calcined to form a composite catalyst that includes the OASA, the second zeolite, a first metal component, a second metal component, the binder, and the support material. In some implementations, using a mixing method, a first precursor for the first metal component, a second precursor for the second metal component, and the support material are added to the catalyst precursor mixture prior to extruding the catalyst paste so that the catalyst precursor mixture contains these additives. In other implementations, using an impregnation method, the first precursor for the first metal component and the second precursor for the second metal component are added to the catalyst extrudate after extruding the catalyst paste.

### Hydrocracking Process

FIG. 3 is an example process flow diagram of a method of hydrocracking using a composite catalyst of this disclosure. In FIG. 3, process 300 starts with step 302 of flowing a hydrocarbon feed including a heavy oil into a hydrotreating and hydrocracking units. In hydrotreating reactor, the majority of the impurities (such as S, N, metals) are removed. The catalysts used in the hydrotreating reactor can be any commercialized hydrotreating catalysts from heavy oil hydrotreating catalyst vendors. The hydrocracking using composite catalyst of this disclosure is used in hydrocracking unit, and in step 304, the hydrocarbon feed is hydrocracked in the hydrocracking unit using a composite catalyst. The composite catalyst includes an OASA having mesopores, a zeolite component having micropores, a first metal component, a second metal component, and a support material. During the hydrocracking, at least a fraction of the heavy oil is converted within the mesopores into an intermediate, and at least a fraction of the intermediate is further converted within the micropores to form a product stream comprising a middle-distillate fraction.

FIG. 4 is an example of a processing facility 400 that directly converts crude oil into petrochemicals, including both olefinic and aromatic petrochemicals. The catalyst described in this disclosure can be used in this processing facility, although the number and types of units are not limited to the example shown.

In some implementations, a feed stream 402 of crude oil or condensate, is received into a feedstock separation system 404 of the processing facility 400. The feedstock separation system 404 separates the feed stream 402 into a light fraction or lights stream 406, such as less than about 180° C., light fraction (e.g., light naphtha or heavy naphtha fraction), and a heavy fraction or heavies stream 408, such as greater than about 160° C., or greater than about 180° C. The heavies stream 408 is then fed to a hydroprocessing system 310, for example, using the composite catalyst described herein to broaden the range of carbon numbers that may be processed by the hydroprocessing system 410. In other implementations, the feed stream is not separated before being fed to the hydroprocessing system 410.

In some examples, the feedstock separation system 404 can be a flash separation device such as a flash drum. For instance, the feedstock separation system 404 can be a single stage separation device such as a flash separator. In various implementations, the cut point is about 160° C., or about 180° C. In some implementations, the feedstock separation system 404 can operate in the absence of a flash zone. For instance, the feedstock separation system 404 can include a cyclonic separation device, a splitter, or another type of separation device based on physical or mechanical separation of vapors and liquids. In a cyclonic phase separation device, vapor and liquid flow into the device through a cyclonic geometry. The vapor is swirled in a circular pattern to create forces that cause heavier droplets and liquid to be captured and channeled to a liquid outlet. Vapor is channeled to a vapor outlet. The cyclonic separation device operates isothermally and with very low residence time. The cut point of the feedstock separation system 404 can be adjusted based on factors such as the vaporization temperature, the fluid velocity of the material entering the feedstock separation system 404, or both, or other factors.

The heavies stream 408 is routed to a hydroprocessing system 410 which includes a hydrotreating reactor 412 for removal of impurities. The hydrotreating reactor 412 can carry out one or more of the following processes, generally in separate layers or zones, hydrodemetallization, hydrodearomatization, hydrodenitrogenation, and hydrodesulfurization. In some examples, the hydrotreating reactor 412 can include multiple catalyst beds, such as two, three, four, five, or another number of catalyst beds. In some examples, the hydrotreating reactor 412 can include multiple reaction vessels each containing one or more catalyst beds of the same or different function. The hydrotreating reactor 412 provides a feedstock 416 for a downstream hydrocracking reactor 414 which converts heavier fractions in the feedstock 416 to light products.

As used herein, a system is an integrated group of processing equipment configured to perform a particular function, such as separations, hydroprocessing, cracking, hydrogen production, and the like. Further, some systems may include vessels to perform multiple functions. For example, a hydroprocessing system may include separation vessels to separate products into multiple streams. A system may include a single vessel, or multiple vessels, and all associated catalysts, pumps, valves, compressors, and process equipment used to perform the designated function.

For example, the hydroprocessing system 410 may include a single vessel for hydrotreating reactor 412 having a single catalyst zone or multiple catalyst zones. In other examples, the hydroprocessing system 410 includes multiple hydrotreating reactor vessels, including multiple zones, or both, wherein each reactor or zone may use different catalysts and conditions to perform different functions, such as hydrodesulfurization, hydrodemetalation, and the like. A hydrogen feed 418 is provided to the hydroprocessing system 410, for example, to the hydrotreating reactor 412 or both the hydrotreating reactor 412 and the hydrocracking reactor 414.

In some examples, hydroprocessing increases the paraffin content or decreases the viscosity as measured by the Bureau of Mines Correlation Index (BMCI) of a feedstock, such as using the composite catalyst composition described herein. For example, the heavies stream 408 separated from the feed stream 402 may be improved by saturating multiple carbon-carbon bonds followed by hydrocracking of aromatics, especially polyaromatics, for example, using the hierarchical catalyst described herein.

When hydrotreating a crude oil, contaminants, such as metals, sulfur, and nitrogen, can be removed by passing the feedstock through a series of catalysts, for example, in the hydrotreating reactor 412. In some examples, the sequence of catalysts to perform hydrodemetallization (HDM) and hydrodesulfurization (HDS) can include a hydrodemetallization catalyst, an intermediate catalyst, and a hydrodesulfurization catalyst. In an embodiment, the hydrotreating reactor 412 includes a series of layered catalyst beds forming zones. For example, an HDM zone may form a top layer, over an intermediate or transition zone, and an HDS zone, among others. In some implementations, a hydrodenitrogenation (HDN) zone, a hydrodearomatization (HDA) zone, or both may be included in layers in the hydrotreating reactor 412.

The catalyst in the HDM zone can be based on a gamma alumina support, with a surface area of between about 140 m²/g and about 240 m²/g. This catalyst has a very high pore volume, such as a pore volume in excess of about 1 cm³/g. The pore size can be predominantly macroporous, which provides a large capacity for the uptake of metals on the surface of the catalyst and optionally dopants. The active metals on the catalyst surface can be sulfides of nickel (Ni), molybdenum (Mo), or both, with a molar ratio of Ni:(Ni+Mo) of less than about 0.15. The concentration of nickel is lower on the HDM catalyst than other catalysts as some nickel and vanadium is anticipated to be deposited from the feedstock itself, thus acting as a catalyst. In some examples, the catalyst can be in the form of alumina extrudates or alumina beads. For instance, alumina beads can be used to facilitate unloading of the catalyst HDM beds in the reactor as the metal uptake can range from 30 to 100% at the top of the bed.

The transition zone can be used to perform a transition between the hydrodemetallization and hydrodesulfurization functions. The intermediate catalyst can have intermediate metal loadings and pore size distribution. The catalyst in the hydrotreating reactor 412 (also termed the HDM/HDS reactor) can be an alumina-based support in the form of extrudates, at least one catalytic metal from group VI (for instance, molybdenum, tungsten, or both), or at least one catalytic metal from group VIII (for instance, nickel, cobalt, or both), or a combination of any two or more of them. The catalyst can contain at least one dopant, such as one or more of boron, phosphorous, halogens, and silicon. The intermediate catalyst in the transition zone can have a surface area of between about 140 m²/g and about 200 m²/g, a pore volume of at least about 0.6 cm³/g, and mesoporous pores sized between about 12 nm and about 50 nm.

The catalyst in the HDS zone can include gamma alumina-based support materials with a surface area towards the higher end of the HDM range, such as between about 180 m²/g and about 240 m²/g. The higher surface area for the HDS catalyst results in relatively small pore volume, such as a pore volume of less than about 1 cm³/g. The catalyst contains at least one element from group VI, such as molybdenum, and at least one element from group VIII, such as nickel. The catalyst also contains at least one dopant, such as one or more of boron, phosphorous, silicon, and halogens. In some examples, cobalt (Co) can be used to provide relatively higher levels of desulfurization. The metals loading for the active phase is higher as the desired activity is higher, such that the molar ratio of Ni:(Ni+Mo) is between about 0.1 and about 0.3 and the molar ratio of (Co+Ni):Mo is between about 0.25 and about 0.85.

A final zone is in the hydrocracking reactor 414, for example, using the composite catalyst described herein as a hydroprocessing catalyst, such as a hydrocracking catalyst. In this zone, heavy compounds, such as polyaromatics, among others, are cracked to form a product stream containing middle-distillate fractions, e.g., diesel oil. In some implementations, the hydroprocessing conditions can be optimized to maximize the yield of the middle-distillate fractions from the feedstock.

In some implementations described herein, the hydroprocessing system 410 processes the heavies stream 408 with hydrogen from the hydrogen feed 418. The hydrogen feed 418 can be either imported to the hydroprocessing system 410, be produced in the hydrocracking reactor 414, or both. The hydrogen may be added at 0.1 mol %, 0.5 mol %, 1 mol %, 5 mol %, or higher, as a proportion of the heavies stream 408.

The reactors 412 and 414 of the hydroprocessing system 410 can operate at a temperature from about 300° C. to about 450° C., such as about 300° C., about 350° C., about 400° C., about 450° C., or another temperature. The reactors 412 and 414 of the hydroprocessing system 410 can operate at a pressure between about 30 bar and about 180 bar, such as about 30 bar, about 60 bar, about 90 bar, about 120 bar, about 150 bar, about 180 bar, or another pressure. The reactors 412 and 414 of the hydroprocessing system 410 can operate with a liquid hour space velocity (LHSV) between about 0.1 h⁻¹ and about 10 h⁻¹, such as about 0.1 h⁻¹, about 0.5 h⁻¹, about 1 h⁻¹, about 2 h⁻¹, about 4 h⁻¹, about 6 h⁻¹, about 8 h⁻¹, about 10 h⁻¹, or another LHSV. The LHSV is the ratio of the flow rate of a reactant liquid through a reactor to the volume of the reactor. In some implementations, the product stream 420 is provided to a products separation system 422 for further separation and processing.

The product separation system 422 may be a cyclonic separator, a flash drum, or any other type of unit described with respect to the feedstock separation system 404. In the product separation system 422, the product stream 420 is separated into streams including, for example, hydrogen, ammonia, hydrogen sulfide, C₁-C₄ gases, and liquid hydrocarbons, such as C₅₊, among others. The hydrogen may be combined with the hydrogen feed 418 to the hydroprocessing system 410. The C₁-C₄ gases and liquid hydrocarbons are sent to a steam cracking system 424 as a steam cracker feed stream 426.

This may improve products from the steam cracking system 424 as the steam cracking of materials having higher hydrogen contents results in better products. Further, removing heavier components decreases the coking tendency in the steam cracker coils. The hydroprocessing system 410 also increases the amount of feed available to the steam cracking system 424 via conversion of heavier compounds to lighter compounds.

The steam cracking system 424 is a combination of gas and liquid furnaces. A steam stream 428 may be provided to one or more of the furnaces of the steam cracking system 424. The furnaces can be flexible or customized for some of the feed sent to the steam cracking system 424. The flow through the steam cracking furnaces of the steam cracking system 424 may provide a total exposure time of about 1 millisecond (ms), about 2 ms, about 5 ms, or about 10 ms. A quench tower may be provided immediately after the steam cracking furnace to cool the effluent from the steam cracking furnace and stop further reactions from taking place. The lights stream 406 provided from the feedstock separation system 404 may be used as a secondary feed.

Product streams formed in the steam cracking system 424 may include a chemicals stream 430, for example, including ethylene, propene, butene, benzene, toluene, and xylene, among others. A pyoil stream 432 may also be formed in the steam cracking system 424.

The product streams 430 and 432 may be provided to downstream systems for separation or the generation of further products, or both. For example, the product streams 430 and 432 may be provided to a products separation system that includes all systems for producing the chemical products from the steam cracking process. In various implementations, the products separation system includes quench columns, primary fractionation columns, compressors, and sets of columns to allow the production of separate streams for ethylene, propylene, mixed C₄ species, and BTX. As described herein, BTX refers to benzene, toluene, and xylene, which may be provided as a mixed aromatics stream, or may be further separated in the products separation system into individual product streams. The products separation system may also include a high-distillation temperature (HDT) and aromatics separation section to treat the pygas and separate BTX from this stream. It may also include selective hydrogenation systems to saturate the tri-olefins produced in the steam cracking furnaces

### EXAMPLES

Two example composite catalyst samples (Cat. 1 and Cat. 2) according to this disclosure were prepared and tested for hydrocracking reaction experiments. For comparison, two reference catalysts (Ref. 1 and Ref. 2) were also prepared and tested for the same reaction experiments. To examine the effect of SiO₂/Al₂O₃ molar ratio in the starting materials and the use of OASA of this disclosure, other catalyst compositions were kept constant as summarized in Table 1. The difference between the four catalyst samples are the type of amorphous silica-alumina and zeolite Y with varying SiO₂/Al₂O₃ molar ratios. In Cat. 1, a Zeolyst commercial CBV-760 (SiO₂/Al₂O₃ molar ratio of about 60) was used to prepare both the OASA and the zeolite component. In Cat. 2, a Zeolyst commercial CBV-720 (SiO₂/Al₂O₃ molar ratio of about 30) was used to prepare both the OASA and the zeolite component. Ref. 1 was prepared using a commercial amorphous silica-alumina Siral 20 from Sasol instead of the OASA and CBV-760 for the zeolite component. Siral 20 has a Al₂O₃/SiO₂ weight ratio of 4 (80/20), which corresponds to SiO₂/Al₂O₃ molar ratio of about 0.4. Ref. 2 was prepared using a commercial amorphous silica-alumina Siral 40 from Sasol instead of the OASA and CBV-760 for the zeolite component. Siral 40 has a Al₂O₃/SiO₂ weight ratio of 1.5 (60/40), which corresponds to SiO₂/Al₂O₃ molar ratio of about 1.1. The surface areas of the OASA samples are about 400 m₂/g higher than those of Siral 20 and 40. Further, generally the OASA can exhibit higher acidity than Siral 20 and 40. More detailed synthetic procedures are provided below.

TABLE 1
Hydrocracking zeolite composite catalyst composition.

| Component | wt. % |
|---|---|
| MoO₃ | 15 |
| NiO | 5 |
| Zeolite Y | 5 |
| Amorphous silica-alumina | 45 |
| Al₂O₃ | 10 |
| Binder | 20 |

### Experiment 1: Cat. 1 Preparation

The OASA was first prepared as follows.

1) 2.84 g of Zeolite Y (CBV-760) was added into a beaker, 30 ml 0.5M of NaOH solution was added to the breaker, and the mixture was stirred at 60° C. for 4 h.

2) In another beaker, 5 g of CTAB and 45 ml of water were added, and the mixture was stirred at room temperature for 4 h.

3) The solution (2) was added dropwise into the solution (1), and stirred at room temperature for 24 h.

4) The mixture was transferred into an autoclave and heated at 100° C. for 48 h.

5) The white precipitate from the autoclave was filtered and washed twice. Between each wash, the cake was blended with 150-200 ml of water, and stirred for 30 min.

6) The filtered cake was dried at 110° C. overnight, and calcinated at 600° C. for 4 h with a heating rate of 2° C./min.

The prepared OASA was used to prepare Cat. 1 as follows.

1) A binder was prepared by mixing 19.11 g CATAPAL alumina from Sasol with a diluted nitric acid solution. The nitric acid solution was prepared by mixing 2.25 mL of a concentrated nitric acid (67-69 wt. %) into 47.7 g of water. The binder was mixed to form a binder paste.

2) A mixture of 0.6 g of zeolite Y (CBV-760), 4.8 g of the prepared OASA, 1.5 g of MoO₃, 2 g of Ni(NO₃)₂·6H₂O, and 1 g of Pural alumina from Sasol was made and thoroughly mixed to form a uniform mixture.

3) This mixture was added to the binder paste and mixed to form an extrudable paste. Depending on the consistency, some amount of water was added to enhance extrusion. The amount of water added is to make sure the mixture forms a tacky agglomerate under light pressure. The extrudable paste was then extruded to make extrudates.

4) The extrudates were dried at 110° C. overnight, and calcined for 4 h at 500° C.

### Experiment 2: Cat. 2 Preparation

The OASA was first prepared as follows.

1) 2.87 g of Zeolite Y (CBV-720) was added into a beaker, 30 ml 0.5M of NaOH solution was added to the breaker, and the mixture was stirred at 60° C. for 4 h.

2) In another beaker, add 5 g of CTAB and 45 ml of water, and the mixture was stirred at room temperature for 4 h.

3) The solution (2) was added dropwise into the solution (1), and was stirred at room temperature for 24 h.

4) The mixture was transferred into an autoclave and heated at 100° C. for 48 h.

5) The white precipitate from the autoclave was filtered and washed twice. Between each wash, the cake was blended with 150-200 ml of water, and stirred for 30 min.

6) The filtered cake was dried at 110° C. overnight, and calcinated at 600° C. for 4 h with a heating rate of 2° C./min.

The prepared OASA was used to prepare Cat. 1 as follows.

1) A binder was prepared by mixing 19.11 g CATAPAL alumina from Sasol with a diluted nitric acid solution. The nitric acid solution was prepared by mixing 2.25 mL of a concentrated nitric acid (67-69 wt. %) into 47.7 g of water. The binder was mixed to form a binder paste.

2) A mixture of 0.6 g of zeolite Y (CBV-720), 5 g of the prepared OASA, 1.5 g of MoO₃, 2 g of Ni(NO₃)₂·6H₂O, and 1 g of Pural alumina from Sasol was made and thoroughly mixed to form a uniform mixture.

3) This mixture was added to the binder paste and mixed to form an extrudable paste. Depending on the consistency, some amount of water was added to enhance extrusion. The amount of water added is to make sure the mixture forms a tacky agglomerate under light pressure. The extrudable paste was then extruded to make extrudates.

4) The extrudates were dried at 110° C. overnight, and calcined for 4 h at 500° C.

### Experiment 3: Ref. 1 Preparation

1) A binder paste was prepared by the same method as described above for Experiments 1 and 2.

2) A mixture of 0.6 g of zeolite Y (CBV-760), 6 g of Siral 20, 1.5 g of MoO₃, 2 g of Ni(NO₃)₂·6H₂O, and 1 g of Pural alumina from Sasol was made and thoroughly mixed to form a uniform mixture.

3) Extrusion was performed by the same method as described above for Experiments 1 and 2.

4) The extrudates were dried at 110° C. overnight, and calcined for 4 h at 500° C.

### Experiment 4: Ref. 2 Preparation

1) A binder paste was prepared by the same method as described above for Experiments 1 and 2.

2) A mixture of 0.6 g of zeolite Y (CBV-760), 5.7 g of Siral 40 HPV, 1.5 g of MoO₃, 2 g of Ni(NO₃)₂·6H₂O, and 1 g of Pural alumina from Sasol was made and thoroughly mixed to form a uniform mixture.

3) Extrusion was performed by the same method as described above for Experiments 1 and 2.

4) The extrudates were dried at 110° C. overnight, and calcined for 4 h at 500° C.

### Hydrocracking Reaction Experiments

The catalyst performance was tested in high throughput reactors with the same feedstock and conditions. A vacuum gas oil (VGO) was used for the feedstock. Their main properties are summarized in Table 2.

TABLE 2
Feedstock properties.

| | |
|---|---|
| Density at 60° F. (15.6° C.) | 0.8842 |
| Nitrogen content (wppm) | 16 |
| Sulfur content (wppm) | 420 |
| Simulation distillation | — |
| Initial boiling point (IBP) | 173 |
| (° C.) | |
| 5 wt. % (° C.) | 316 |
| 10 wt. % (° C.) | 354 |
| 20 wt. % (° C.) | 389 |
| 30 wt. % (° C.) | 408 |
| 40 wt. % (° C.) | 423 |
| 50 wt. % (° C.) | 437 |
| 60 wt. % (° C.) | 451 |
| 70 wt. % (° C.) | 467 |
| 80 wt. % (° C.) | 485 |
| 90 wt. % (° C.) | 507 |
| 95 wt. % (° C.) | 524 |
| End boiling point (EBP) | 561 |
| (° C.) | |

The common catalyst testing conditions for the four catalyst samples are summarized in Table 3. While maintaining the same liquid hourly space velocity (LHSV), pressure, and H₂/oil ratio, the reaction temperature was varied at 360° C., 375° C., and 390° C.

TABLE 3
Catalyst testing conditions.

| | #1 | #2 | #3 |
|---|---|---|---|
| Reaction temperature (° C.) | 360 | 375 | 390 |
| LHSV (h⁻¹) | 2.0 | 2.0 | 2.0 |
| Pressure (bar) | 150 | 150 | 150 |
| H₂/oil volume ratio | 1200 | 1200 | 1200 |

Product yields obtained from the four catalyst samples at 390° C. are summarized in Table 4. The results show that, at the same reaction temperature of 390° C., the composite catalysts (Cat. 1 and Cat. 2) both show higher diesel (30.7% and 30.9%) and naphtha yields (39.0% and 44.7%) than the reference catalysts, demonstrating the advantage of using the OASA described in this disclosure. Further, the unconverted oil (UCO), which is a fraction with a boiling range>350° C., was also substantially lower for the two composite catalysts of this disclosure (25.4% and 18.9%).

The improved conversion of the hydrocarbon feed and yield of the middle-distillate fractions suggests the ability to lower the reaction temperature using the composite catalyst. Based on the performed experiments, the temperature to achieve 57.5 wt. % conversion was estimated for the four catalyst samples, which is shown in Table 5. Advantageously, Cat. 1 and Cat. 2 can achieve the same level of conversion at a lower temperature than the reference catalysts. The results suggest that the hydroprocessing of heavy oil using the composite catalyst can be economically performed at a lower temperature, e.g., less than 400° C., while maintaining a satisfactory conversion and yield level.

TABLE 4
Product yields for four tested catalysts at 390° C.

| | Ref. 1 | Ref. 2 | Cat. 1 | Cat. 2 |
|---|---|---|---|---|
| Gas (wt. %) | 1.09 | 3.37 | 5.98 | 6.92 |
| Naphtha (wt. %) | 10.44 | 24.59 | 39.03 | 44.71 |
| Diesel (wt. %) | 23.77 | 29.67 | 30.66 | 30.88 |
| UCO (wt. %) | 64.94 | 42.81 | 25.35 | 18.88 |

TABLE 5
Temperature to achieve 57.5 wt. % conversion.

| Ref. 1 | Ref. 2 | Cat. 1 | Cat. 2 |
|---|---|---|---|
| 403.4° C. | 390.1° C. | 383.3° C. | 381.2° C. |

### Implementations

An implementation described here provide a method of catalytic hydrocracking. The method includes flowing a hydrocarbon feed comprising a heavy oil into a hydrocracking unit; and hydrocracking the hydrocarbon feed in the hydrocracking unit using a composite catalyst. The composite catalyst includes an ordered amorphous silica-alumina (OASA) having mesopores, a zeolite component having micropores, a first metal component, a second metal component, and a support material, where at least a fraction of the heavy oil is converted within the mesopores into an intermediate, and at least a fraction of the intermediate is further converted within the micropores to form a product stream including a middle distillate fraction.

In an aspect, the OASA is prepared by at least partially hydrolyzing a first zeolite to form the mesopores, and the zeolite component includes a second zeolite.

In an aspect, combinable with any other aspect, the first zeolite includes a zeolite Y.

In an aspect, combinable with any other aspect, the second zeolite includes a zeolite Y.

In an aspect, combinable with any other aspect, the zeolite component includes a third zeolite

In an aspect, combinable with any other aspect, the third zeolite includes a beta zeolite.

In an aspect, combinable with any other aspect, a weight ratio of the OASA to the zeolite component in the composite catalyst is from 5:1 to 20:1.

In an aspect, combinable with any other aspect, the OASA is from 30 wt. % to 50 wt. % of the composite catalyst.

In an aspect, combinable with any other aspect, the first metal component includes molybdenum or tungsten, and the second metal component includes nickel.

In an aspect, combinable with any other aspect, the first metal component is a first metal oxide, and the second metal component is a second metal oxide.

In an aspect, combinable with any other aspect, the support material includes alumina.

In an aspect, combinable with any other aspect, the composite catalyst is an extrudate including a binder.

In an aspect, combinable with any other aspect, the composite catalyst includes: 30-50 wt. % the OASA; 15-25 wt. % the binder; 14-20 wt. % the first metal component; 5-15 wt. % the support material; 4-8 wt. % the second metal component; and 2-15 wt. % the zeolite component.

In an aspect, combinable with any other aspect, the heavy oil includes vacuum gas oil (VGO), residua, bitumen, or heavy crude oil.

In an aspect, combinable with any other aspect, the middle distillate includes diesel oil.

In an aspect, combinable with any other aspect, the hydrocracking is performed at a temperature below 400° C., and a yield of the diesel oil from the hydrocracking is at least 30%.

An implementation described here provides a method of preparing a hydrocracking catalyst. The method includes: forming an ordered amorphous silica-alumina (OASA) including mesopores by at least partially hydrolyzing a first zeolite; mixing the OASA with a second zeolite to form a catalyst precursor mixture; adding a binder and a support material to the catalyst precursor mixture to form a catalyst paste; extruding the catalyst paste to form a catalyst extrudate; and calcining the catalyst extrudate to form a composite catalyst. The composite catalyst includes the OASA, the second zeolite, a first metal component, a second metal component, the binder, and the support material.

In an aspect, combinable with any other aspect, the method further includes adding a first precursor for the first metal component, a second precursor for the second metal component, and the support material to the catalyst precursor mixture prior to extruding the catalyst paste.

In an aspect, combinable with any other aspect, the method further includes, after extruding the catalyst paste and prior to calcining the catalyst extrudate, adding a first precursor for the first metal component and a second precursor for the second metal component to the catalyst extrudate using an impregnation method.

In an aspect, combinable with any other aspect, forming the OASA includes: adding the first zeolite in an alkali aqueous solution to form a mixture solution; adding a structure-directing agent to the mixture solution; holding the mixture solution at a first reaction temperature for 24 h or more; recovering a precipitate from the mixture solution; and calcining the precipitate to form the OASA.

An implementation described here provides an extrudate catalyst composition including: 30-50 wt. % an ordered amorphous silica-alumina (OASA) having mesopores; 15-25 wt. % a binder; 14-20 wt. % a first metal component; 5-15 wt. % a support material; 4-8 wt. % a second metal component; and 2-15 wt. % a zeolite component.

In an aspect, combinable with any other aspect, the first metal component includes molybdenum oxide, the second metal component includes nickel oxide, and the support material includes alumina.

In an aspect, combinable with any other aspect, the OASA is formed by at least partially hydrolyzing a first zeolite Y, and the zeolite component includes a second zeolite Y and a beta zeolite.

In an aspect, combinable with any other aspect, the first zeolite Y is CBV-720 or CBV-760.

In an aspect, combinable with any other aspect, the second zeolite Y is CBV-720 or CBV-760.

In an aspect, combinable with any other aspect, the OASA has a silica to aluminum (SiO₂/Al₂O₃) molar ratio greater than 20.

While the disclosure has been shown in some of its forms, it should be apparent to those skilled in the art that it is not so limited, but is susceptible to various changes and modifications without departing from the scope of the disclosure based on experimental data or other optimizations considering the overall economics of the process. Accordingly, it is appropriate that the appended claims be construed broadly and in a manner consistent with the scope of the disclosure.

What is claimed is:

1. A method of catalytic hydrocracking, the method comprising:
flowing a hydrocarbon feed comprising a heavy oil into a hydrocracking unit; and
hydrocracking the hydrocarbon feed in the hydrocracking unit using a composite catalyst comprising,
an ordered amorphous silica-alumina (OASA) having mesopores,
a zeolite component having micropores,
a first metal component,
a second metal component, and
a support material,
wherein at least a fraction of the heavy oil is converted within the mesopores into an intermediate, and at least a fraction of the intermediate is further converted within the micropores to form a product stream comprising a middle distillate fraction.

2. The method of claim 1, wherein the OASA is prepared by at least partially hydrolyzing a first zeolite to form the mesopores, and the zeolite component comprises a second zeolite.

3. The method of claim 2, wherein the first zeolite comprises a zeolite Y.

4. The method of claim 2, wherein the second zeolite comprises a zeolite Y.

5. The method of claim 2, wherein the zeolite component comprises a third zeolite.

6. The method of claim 5, wherein the third zeolite comprises a beta zeolite.

7. The method of claim 1, wherein a weight ratio of the OASA to the zeolite component in the composite catalyst is from 5:1 to 20:1.

8. The method of claim 1, wherein the OASA is from 30 wt. % to 50 wt. % of the composite catalyst.

9. The method of claim 1, wherein the first metal component comprises molybdenum or tungsten, and the second metal component comprises nickel.

10. The method of claim 1, wherein the first metal component is a first metal oxide, and the second metal component is a second metal oxide.

11. The method of claim 1, wherein the support material comprises alumina.

12. The method of claim 1, wherein the composite catalyst is an extrudate comprising a binder.

13. The method of claim 12, wherein the composite catalyst comprises:
30-50 wt. % the OASA;
15-25 wt. % the binder;
14-20 wt. % the first metal component;
5-15 wt. % the support material;
4-8 wt. % the second metal component; and
2-15 wt. % the zeolite component.

14. The method of claim 1, wherein the heavy oil comprises vacuum gas oil (VGO), residua, bitumen, or heavy crude oil.

15. The method of claim 1, wherein the middle distillate comprises diesel oil.

16. The method of claim 14, wherein the hydrocracking is performed at a temperature below 400° C., and a yield of the diesel oil from the hydrocracking is at least 30%.

17. A method of preparing a hydrocracking catalyst, the method comprising:
forming an ordered amorphous silica-alumina (OASA) comprising mesopores by at least partially hydrolyzing a first zeolite;
mixing the OASA with a second zeolite to form a catalyst precursor mixture;
adding a binder and a support material to the catalyst precursor mixture to form a catalyst paste;
extruding the catalyst paste to form a catalyst extrudate; and
calcining the catalyst extrudate to form a composite catalyst comprising,
the OASA,
the second zeolite,
a first metal component,
a second metal component,
the binder, and
the support material.

18. The method of claim 17, further comprising adding a first precursor for the first metal component, a second precursor for the second metal component, and the support material to the catalyst precursor mixture prior to extruding the catalyst paste.

19. The method of claim 17, after extruding the catalyst paste and prior to calcining the catalyst extrudate, adding a first precursor for the first metal component and a second precursor for the second metal component to the catalyst extrudate using an impregnation method.

20. The method of claim 17, wherein forming the OASA comprises:
adding the first zeolite in an alkali aqueous solution to form a mixture solution;
adding a structure-directing agent to the mixture solution;
holding the mixture solution at a first reaction temperature for 24 h or more;
recovering a precipitate from the mixture solution; and
calcining the precipitate to form the OASA.

21. An extrudate catalyst composition comprising:
30-50 wt. % an ordered amorphous silica-alumina (OASA) having mesopores;
15-25 wt. % a binder;
14-20 wt. % a first metal component;
5-15 wt. % a support material;
4-8 wt. % a second metal component; and
2-15 wt. % a zeolite component.

22. The extrudate catalyst composition of claim 21, wherein the first metal component comprises molybdenum oxide, the second metal component comprises nickel oxide, and the support material comprises alumina.

23. The extrudate catalyst composition of claim 21, wherein the OASA is formed by at least partially hydrolyzing a first zeolite Y, and the zeolite component comprises a second zeolite Y and a beta zeolite.

24. The extrudate catalyst composition of claim 21, wherein the first zeolite Y is CBV-720 or CBV-760.

25. The extrudate catalyst composition of claim 21, wherein the second zeolite Y is CBV-720 or CBV-760.

26. The extrudate catalyst composition of claim 21, wherein the OASA has a silica to aluminum (SiO₂/Al₂O₃) molar ratio greater than 20.
